(19) United States
(12) Patent Application Publication
(10) Pub. No.: US 2018/0373658 A1
(43) Pub. Date: Dec. 27, 2018

(54) CONFLICT RESOLUTION ON GPIO PIN MULTIPLEXING

(71) Applicant: Microsoft Technology Licensing, LLC, Redmond, WA (US)

(72) Inventor: Neil Leonard SHIPP, Bellevue, WA (US)

(21) Appl. No.: 15/634,836

(22) Filed: Jun. 27, 2017

(51) Int. Cl. G06F 13/364; G06F 15/78

(52) U.S. Cl. CPC G06F 13/364; H04L 67/10; G06F 15/7807

(57) ABSTRACT

An electronic chip may include a plurality of general purpose input/output (GPIO) pads. One or more multiplexors may be connected with one or more of the GPIO pads and connected with one or more hardware blocks. The one or more multiplexors control which hardware block is connected to the respective GPIO pad. An input select multiplexor may be connected to at least a subset of the GPIO pads via the at least one multiplexor and to a hardware block. The input select multiplexor may also control which GPIO pad is connected to the hardware block. A processor may be configured to reserve a first pad linked to a hardware block via a multiplexor, determine that the first pad is associated with the input select multiplexor, receive a second reservation request for a second pad associated with the input select multiplexor, and deny the second reservation request.

### BACKGROUND

The present disclosure relates to access control for input/output resources for hardware components, and more particularly, to conflict resolution on general purpose input/output pins.

An electronic processing component such as a system on a chip (SoC) may include various pins having designated uses. Other pins on the chip may not have a dedicated use and may be designated as general purpose input/output (GPIO) pins. Conventionally, each GPIO pin was controlled by a single multiplexor associated with a select register that designated which internal hardware block is connected to the GPIO pin. Generally, the GPIO pin would be statically assigned to a hardware block.

Some recent SoCs include an input select register associated with a hardware block and one or more GPIO pins. The input select register may control an input select multiplexor to select from which pins the hardware component receives input. On such devices, it may be possible for the multiplexor register and the input select register to associate different hardware blocks with the same GPIO pin or the same hardware block with multiple GPIO pins, which could lead to erroneous routing of signals.

Thus, there is a need in the art for improvements in access control for GPIO pins.

### SUMMARY

The following presents a simplified summary of one or more implementations of the present disclosure in order to provide a basic understanding of such implementations. This summary is not an extensive overview of all contemplated implementations, and is intended to neither identify key or critical elements of all implementations nor delineate the scope of any or all implementations. Its sole purpose is to present some concepts of one or more implementations of the present disclosure in a simplified form as a prelude to the more detailed description that is presented later.

In an example, a method of controlling access to general purpose input/output (GPIO) pads of an electronic chip includes maintaining at least one table indicating one or more associations between the GPIO pads, one or more hardware blocks, one or more input select multiplexors, and one or more programs. The method includes reserving a first pad linked to a hardware block via a multiplexor. The method includes determining that the first pad is currently connected with an input select multiplexor in response to reserving the first pad based on the at least one table. The method includes receiving a second reservation request for a second pad. The method includes determining that the second pad is associated with the input select multiplexor based on the at least one table. The method includes denying the second reservation request in response to determining that the first pad is currently connected to the input select multiplexor associated with the second pad.

In another example, an electronic chip may include a plurality of general purpose input/output (GPIO) pads. The electronic chip may include one or more multiplexors connected with one or more of the GPIO pads and connected with one or more hardware blocks, wherein the one or more multiplexors control which hardware block is connected to the respective GPIO pad. The electronic chip may include a register associated with each multiplexor. The electronic chip may include an input select multiplexor associated with at least a subset of the GPIO pads via the one or more multiplexors and to a hardware block, wherein the input select multiplexor controls which GPIO pad is connected to the hardware block. The electronic chip may include a memory storing one or more parameters or instructions for executing an operating system and at least one processor coupled to the memory. At least one processor may be configured to maintain at least one table indicating one or more associations between the GPIO pads, the one or more hardware blocks, the input select multiplexor, and one or more programs. At least one processor may be configured to reserve a first pad linked to a hardware block via a multiplexor. At least one processor may be configured to determine that the first pad is currently connected with the input select multiplexor in response to reserving the first pad based on the at least one table. At least one processor may be configured to receive a second reservation request for a second pad;

determine that the second pad is associated with the input select multiplexor based on the at least one table. At least one processor may be configured to deny the second reservation request in response to determining that the first pad is currently connected to the input select multiplexor associated with the second pad.

In another example, a method of controlling access to GPIO pads on a SoC may include generating at least one configuration table to map possible connections between GPIO pads and hardware blocks on the SoC based on a hardware specification. The method may include maintaining two run time tables that track which programs are currently using which GPIO pads and which hardware blocks are currently connected to a GPIO pad. The method may include receiving a request, from a program, to open a connection between a hardware block and a GPIO pad. The method may include checking the two run time tables to determine whether another program or block is using the GPIO pad.

Additional advantages and novel features relating to implementations of the present disclosure will be set forth in part in the description that follows, and in part will become more apparent to those skilled in the art upon examination of the following or upon learning by practice thereof.

### DESCRIPTION OF THE FIGURES

In the drawings:

FIG. 1 is a block diagram of an example electronic chip, in accordance with an implementation.

FIG. 2 is a circuit diagram of example input/output control circuitry in an electronic chip, in accordance with an implementation.

FIG. 3 is a block diagram of an example input/output manager, in accordance with an implementation.

FIG. 4 is a flowchart of an example method of managing access to GPIO pins in an electronic chip in accordance with an implementation.

FIG. 5 is a flowchart of another example method of managing access to GPIO pins in an electronic chip in accordance with an implementation.

FIG. 6 is block diagram of an example computer device in accordance with an implementation.

### DETAILED DESCRIPTION

The present disclosure provides devices and methods for controlling access to GPIO pins of an electronic chip. In an implementation, the electronic chip may be a system on a chip (SoC) that may be configured to perform multiple operations. The SoC may include one or more processors that may execute instructions stored in a memory. The SoC may also include one or more specialized hardware blocks that perform specific operations. The SoC may include multiple pins extending from the chip that allow for connections to other devices (e.g., a motherboard). Many of the pins may have dedicated uses that are fixed by the chip manufacturer. Some of the pins, however, may be designated as general purpose input-output (GPIO) pins. Each GPIO pin may be associated with an on-chip pad. The term “pad” is a semiconductor design term meaning “chip connection to outside world.” The pad may include dedicated circuitry for configuring the pin. The terms GPIO pin and GPIO pad may be used interchangeably herein to refer to the GPIO pin and the corresponding GPIO pad.

A SoC may be programmable to connect one or more hardware blocks to each GPIO pin. The SoC may include input-output (I-O) control circuitry that may be configured to establish a connection between the hardware blocks and the GPIO pad in the input and/or output directions. For example, output may be controlled by a multiplexor associated with a GPIO pin. Multiple hardware blocks may be connected to the input of the multiplexor. A multiplexor register may be connected to the select lines of the multiplexor to configure which hardware block has access to the GPIO pad. As another example, input from a GPIO pin may be routed via an input select multiplexor with an output connected to a hardware block. Multiple GPIO pads may be connected to separate multiplexors, which may each be connected to the input of the input select multiplexor. An input select register may be connected to the select lines of the input select multiplexor to configure which GPIO pad provides input to the hardware block. Because connections to the GPIO pad may be configured by two different registers, it may be possible to set the registers such that there are conflicting connections to the GPIO pad. For example, a first program may configure the multiplexor register for output from a hardware block via a GPIO pad. A second program may configure an input select register to provide input from the GPIO pad to a hardware block. Accordingly, there may be a conflict over whether a signal on the GPIO pin is input or output.

The present disclosure provides, in an implementation, an input-output manager that monitors connections between hardware blocks, multiplexor registers, input select registers, and GPIO pads. A program may request the input-output manager to reserve a GPIO pad for input, output, or both. The input-output manager may determine whether the requested resources are available. If the resources are available, the input-output manager may configure the registers to provide the requested resources. If the resources are unavailable, the input-output manager may deny the request in a manner that allows the program to handle the error.

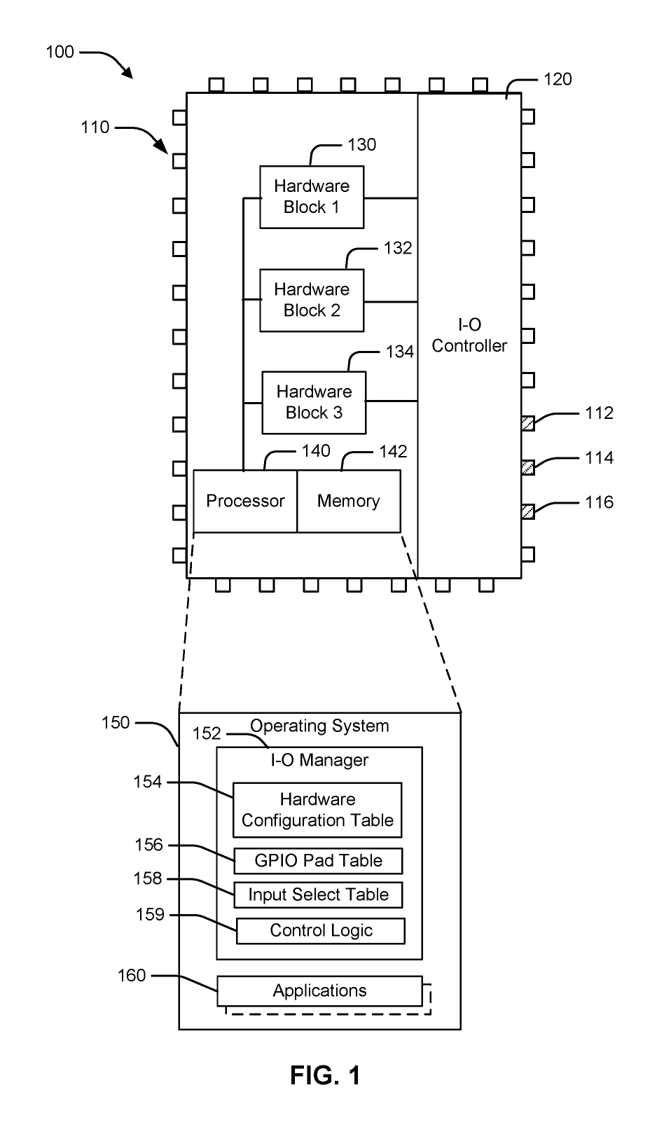

Referring now to FIG. 1, an example chip 100 includes multiple pins 110. Most of the pins 110 may be dedicated to specific purposes. GPIO pins 112, 114, 116, however, may be configurable for input, output, or both with respect to one or more hardware blocks 130, 132, 134. Although the GPIO pins 112, 114, 116 are illustrated as grouped together, it should be understood that the number, locations, and uses of the pins may vary based on design of the chip 100. A chip manufacturer may provide documentation of the pin uses. For example, a chip manufacturer may provide a hardware specification that may be provided by chip firmware to an operating system 150. In an implementation, Advanced Configuration and Power Interface (ACPI) may be used to provide the hardware specification.

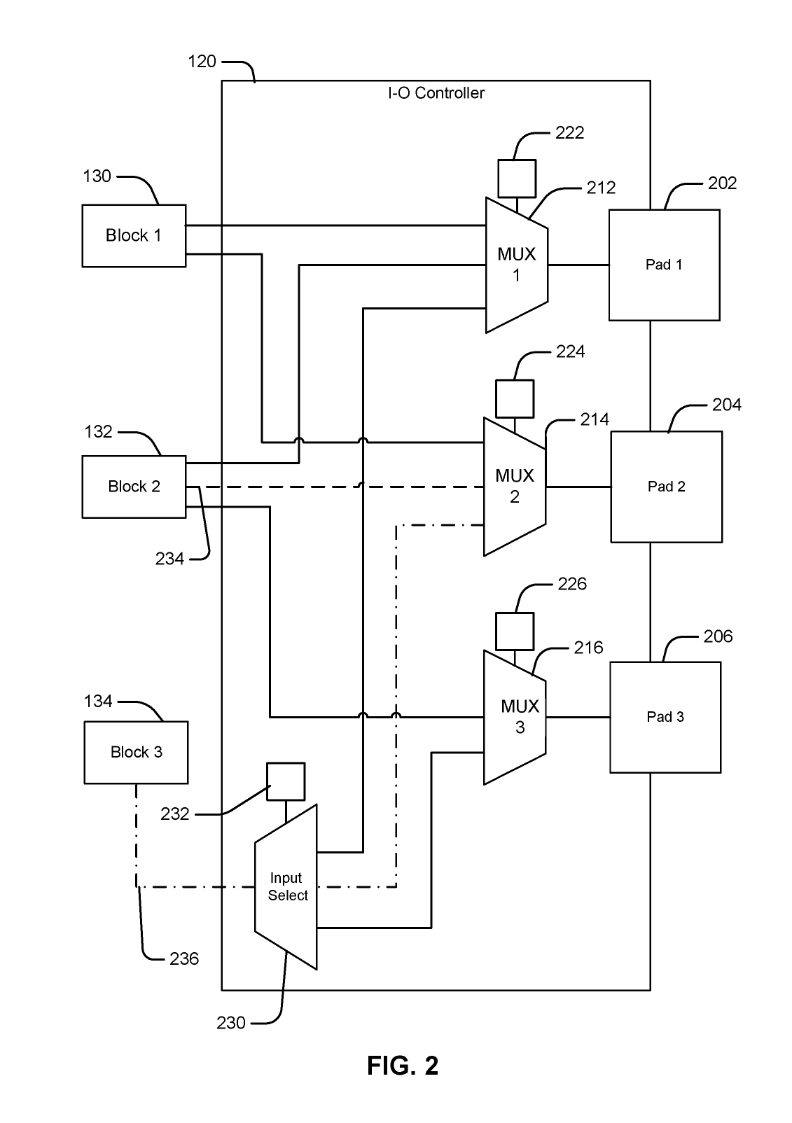

The chip 100 may also include an input-output (I-O) controller 120. The input-output controller 120 may include circuitry for controlling access to the GPIO pins 112, 114, 116. As explained in further detail below with respect to FIG. 2, the input-output controller 120 may include configurable multiplexors connecting the hardware blocks 130, 132, 134 to the GPIO pins 112, 114, 116. The hardware specification may indicate available configurations of the input-output controller 120 (e.g., register settings) that provide access for each hardware block 130, 132, 134 to the GPIO pins 112, 114, 116

The hardware blocks 130, 132, 134 may include any hardware block that may be granted access to one or more of GPIO pins 112, 114, 116. The hardware blocks 130, 132, 134 may be circuits defined in the silicon of chip 100. For example, the hardware blocks 130, 132, 134 may include one or more: processors, hardware accelerators, universal asynchronous receiver/transmitters (UARTs), interface modules, modems, antennas, memories, or other chip components. The hardware blocks 130, 132, 134 may be used by a program to perform an operation. In particular, the hardware blocks 130, 132, 134 may perform an input or output operation. For example, a program may open a first connection between hardware block 130 and GPIO pin 112 to receive input and open a second connection between hardware block 130 and GPIO pin 114 for output. The hardware block 130 may receive the input, perform its designated operation, and provide the output. In another example, the hardware block 130 may communicate with one of the other hardware blocks 132, 134 or the processor 140. For example, the hardware block 132 may be a modem that receives data from processor 140, performs signal processing, and outputs a signal to GPIO pin 116 for transmission via an external antenna.

The chip 100 may include a memory 142 and processor 140 configured to control the operation of chip 100. Memory 142 may be configured for storing data and/or computer-executable instructions defining and/or associated with an operating system 150 and/or application 160, and processor 140 may execute operating system 150 and/or application 160. An example of memory 142 can include, but is not limited to, a type of memory on a chip, such as random access memory (RAM), read only memory (ROM), volatile memory, non-volatile memory, and any combination thereof. Memory 142 may store local versions of applications being executed by processor 140.

The chip 100 may include one or more processors 140 for executing instructions. An example processor 140 can include, but is not limited to, any processor specially programmed as described herein, including a controller, microcontroller, application specific integrated circuit (ASIC), field programmable gate array (FPGA), or other programmable logic or state machine. The processor 140 may include other processing components such as an arithmetic logic unit (ALU), registers, and a control unit.

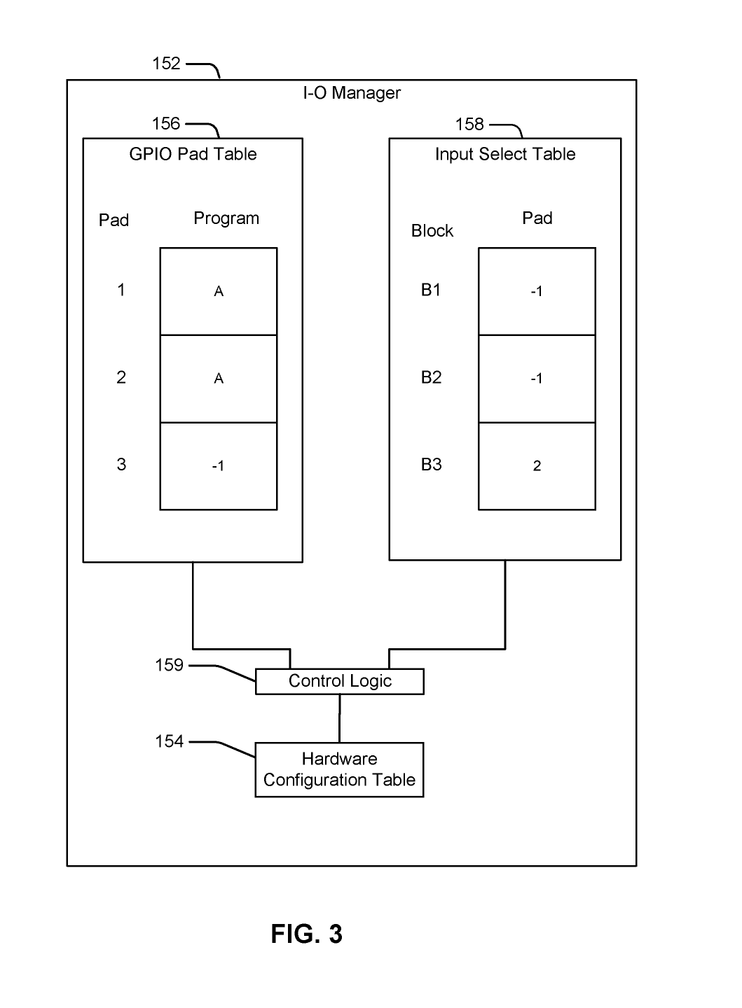

The operating system 150 may include instructions (such as input-output (I-O) manager 152 and application 160) stored in memory 142 and executable by the processor 140. The operating system 150 may include the input-output (I-O) manager 152 for managing the input-output controller 120 and the pins 110 including the GPIO pins 112, 114, 116, in particular. For example, the input-output manager 152 may control the input-output controller 120 by setting the values of various registers. The input-output manager 152 may receive requests to open a connection via the input-output controller 120, determine whether the request can be satisfied, and either open the connection or deny the request. In an implementation, the input-output manager 152 may be a driver for the input-output controller 120. The input-output manager 152 may include a hardware configuration table 154 for storing information regarding the input-output controller 120, a GPIO pad table 156 for monitoring the current configuration of GPIO pads (e.g., state of MUX registers), and an input select table 158 for monitoring the current configuration of input select multiplexors (e.g., state of input select registers), and control logic 159 for updating the GPIO pad table 156 and input select table 158 based on requests. The hardware configuration table 154 may be provided by the chip 100. For example, the hardware configuration table 154 may be pre-loaded into memory 142 (e.g., within a ROM) or provided by chip firmware. In an implementation, the hardware configuration table 154 may be an ACPI table. The GPIO pad table 156 and the input select table 158 are discussed in further detail below with respect to FIG. 3. The control logic 159 may include executable instructions (e.g., rules) to determine whether a requested access request is allowed. The control logic 159 may be configured, in part, based on the hardware configuration table 154. For example, the control logic 159 may detect conflicts (e.g., between requested GPIO pins and already assigned GPIO pins) based on the hardware configuration table 154. The control logic 159 may update the GPIO pad table 156 and the input select table 158 based on access requests.

The applications 160 may include one or more applications executable by the processor 140. The applications 160 may include operating system processes as well as user installed programs. The applications 160 may be referred to as programs. The applications 160 may request access to one or more of GPIO pins 112, 114, 116 from the input-output manager 152. If access is granted, the application 160 may utilize the granted one of the GPIO pins 112. 114. 116. If access is denied, the application 160 may receive an error code, which may be used to correct the request (e.g., request a different GPIO pin) or generate an error report or debugging message.

Turning now to FIG. 2, an example input-output controller 120 provides configurable connections between one or more hardware blocks 130, 132, 134 and GPIO pads 202, 204, 206. Each of GPIO pads may correspond to one of GPIO pins 112, 114, 116 of FIG. 1. For example, hardware blocks 130, 132, 134 may be connected to an input side of multiplexor 212 (MUX 1). The output side of multiplexor 212 may be connected to GPIO pad 202. A register 222 may be connected to the select lines of multiplexor 212 to determine which hardware block 130, 132, 134 is connected to the GPIO pad 202. The input-output manager 152 (FIG. 1) may set the value of the register 222 to dynamically configure the input-output controller 120 to provide access to GPIO pad 202. Similarly, the multiplexor 214 (MUX 2) may be controlled by register 224 to select between hardware blocks 130, 132 to connect to GPIO pad 204. As another example, multiplexor 216 (MUX 3) may be controlled by register 226 to select between hardware blocks 132, 134 to connect to GPIO pad 206. Generally, the input-output controller 120 may include a multiplexor and controlling register corresponding to each GPIO pin.

The input-output controller 120 may also include one or more input select multiplexors 230. The output of the input select multiplexor 230 may be connected to the hardware block 134. The input side of the input select multiplexor 230 may connected to one or more GPIO pads such as GPIO pads 202, 204, and 206. An input select register 232 may be connected to the select lines of the input select multiplexor 230 to select one of the GPIO pads for input. The input-output manager 152 (FIG. 1) may set the value of the input select register 232 to dynamically configure the input-output controller 120 to provide input to hardware block 134. It should be understood that the input-output controller 120 may include similar input select multiplexors and input select registers, each of which may be connected to one of the hardware blocks 130, 132, which are not shown for simplicity. The hardware configuration table 154 (FIG. 1) may provide the hardware specification indicating the available connections on a specific chip. The hardware configuration table 154 may indicate an association between two components when a physical connection exists. It should be understood that although two components are physically connected, a multiplexor and associated register may be used to determine which components are currently connected at any point in time. That is, by setting a value of a register, the associated multiplexor may set a logical connection between the components.

As mentioned above, it may be possible to set the registers 222, 224, 226 and the input select register 232 in a manner that causes conflict over a GPIO pad/pin. For example, if the register 224 is set to provide output from hardware block 132 to GPIO pad 204, as indicated by dashed line 234, and the input select register 232 is set to provide input from GPIO pad 204 to hardware block 134, as indicated by dashed line 236, it may be unclear as to whether a signal on the GPIO pad 204 is output from hardware block 132 or input for hardware block 134.

Turning now to FIG. 3, the input-output manager 152 may prevent GPIO pin conflicts by ensuring that a GPIO pin is not separately registered to receive output from a hardware block and to provide input to a different hardware block. In an implementation, the input-output manager 152 may include two tables for monitoring the current configuration of the input-output controller 120: GPIO pad table 156 and input select table 158. The term “table” is not meant to be limiting to any particular data structure. Instead, the term “table” as used herein refers to any data structure for storing an association between elements. For example, the GPIO pad table 156 may store associations between a GPIO pad and a program indicating that the GPIO pad is currently utilized by the program. In an implementation, for example, the GPIO pad table 156 may be an array where a respective stored value indicates a program claiming a GPIO pad corresponding to the respective index. If the respective GPIO pad is not claimed, the value may be a negative value (e.g., −1) or other initial value. Further, the input select table 158 may store associations between a hardware block and GPIO pad indicating that the hardware block is currently connected to the GPIO pad (e.g., via an input select multiplexor associated with the hardware block). In an implementation, for example, the input select table 158 may be an array where a respective entry includes a value indicating an identifier of a GPIO pad currently connected to the hardware block corresponding to the respective array index. A negative value (e.g., −1) or other initial value may indicate that no GPIO pad is currently connected to the hardware block. In order for a request to use a GPIO pad to be granted, the input-output manager 152 checks the corresponding configured values in both the GPIO pad table 156 and the input select table 158 to make sure the GPIO pad is not already in use.

As illustrated, for example, a program A (which may be an application 160), may first request to open an output connection from hardware block 130 (HW block index 1) to GPIO pad 202 (pad index 1) via multiplexor 212. The control logic 159 may check GPIO pad table 156 to determine whether GPIO pad 202 is currently claimed. If the GPIO pad 202 is already claimed, the control logic 159 may reject the first request. The control logic 159 may also determine whether the requested hardware block is associated with an input select register by checking the hardware configuration table 154. In this case, the hardware block 130 may not be associated with an input select register, or no value may be set for any input select register in the input select table 158. If the GPIO pad 202 is not claimed (e.g., pad index 1 of GPIO pad table 156 includes a value of −1) and the hardware block 130 is not associated with an input select register (e.g., HW block index 1 of input select table 158 includes a value of −1 to indicate no associated input select setting), the control logic 159 may connect the GPIO pad 202 to the hardware block 130 by setting the register 222. It should be appreciated that the control logic 159 may check the GPIO pad table 156 and the input select table 158 in either order. Additionally, the control logic 159 may maintain the GPIO pad table 156 and the input select table 158 by setting, in the GPIO pad table 156, the value of GPIO pad 202 (pad index 1) to “A”, where “A” is an identifier of the program A. Additionally, if the hardware configuration table 154 indicates that an input select register is associated with the hardware block 130, the control logic 159 may set the value of hardware block 130 (HW block index 1) in input select table 158 to pad index 1 to indicate a current connection between the hardware block 130 and the GPIO pad 202. In the illustrated example, however, no input select register is associated with hardware block 130, so the input select table 158 may retain a −1 value.

Further, the same program A may make a second request to open an input connection from hardware block 134 (HW block index 3) to GPIO pad 204 (pad index 2) via multiplexor 214. The control logic 159 may check GPIO pad table 156 to determine whether GPIO pad 204 is currently claimed. If the GPIO pad 204 is already claimed, the control logic 159 may reject the second request. The control logic 159 may also determine whether the requested GPIO pad is associated with an input select register. In this case, the GPIO pad 204 may be associated with an input select register 232, but no value may be set for the input select register 232 in the input select table 158. Accordingly, the control logic 159 may grant access to the GPIO pad 204 by setting the register 224 to the hardware block 134. Further, the control logic 159 may maintain the GPIO pad table 156 and the input select table 158 by setting, in the GPIO pad table 156, the value of GPIO pad 204 (pad index 2) to “A” to represent the grant to program A. Additionally, in the input select table 158, the control logic 159 may also set the value of hardware block 134 (HW block index 3) to the value 2, where the value 2 is the index of GPIO pad 204 because GPIO pad 204 is currently connected to the input select register 232 corresponding to hardware block 134. Thus, in this example, based on the granted first and second access requests, program A may then utilize both GPIO pad 202 and GPIO pad 204 using hardware block 130 and hardware block 134, respectively (e.g., the first output connection from hardware block 130 to GPIO pad 202, and the second input connection from hardware block 134 to GPIO pad 204). The GPIO pad table 156 and the input select table 158 may indicate this status as illustrated in FIG. 3.

A second program B may attempt to open an output connection for hardware block 134 to GPIO pad 202 via multiplexor 212. The control logic 159 may detect that the GPIO pad table 156 already indicates that GPIO pad 202 (pad index 1) is claimed by program A. The control logic may then deny the request.

Program A, however, may be allowed to open an input connection between hardware block 130 and GPIO pad 202 because the single program A may be able to manage both input and output between the same hardware block 130 and GPIO pad 202. For example, if program A requests to open an input connection from GPIO pad 202 to hardware block 130, the control logic 159 may determine that program A already has access to GPIO pad 202 (pad index 1) based on GPIO pad table 156. The control logic 159 may also determine that hardware block 130 is available based on the input select table 158. Accordingly, the control logic 159 may open the input connection.

If the second program B attempts to open an input connection between GPIO pad 206 and hardware block 134 via input select multiplexor 230, the control logic 159 may determine that the GPIO pad 206 is available based on GPIO pad table 156 storing a value of −1 indicating no program has claimed GPIO pad 206. Similarly, the multiplexor 216 may not be locked. However, the control logic 159 may also determine that the hardware block 134 is associated with an input select multiplexor/register 230/232 based on the hardware configuration table 154 and/or the input select table 158. The input select table 158 may further indicate that the hardware block 134 is currently connected to GPIO pad 204 (pad index 2) (e.g., hardware block 134 is currently receiving input from GPIO pad 204). Accordingly, the control logic 159 may deny the request to access GPIO pad 206 although GPIO pad 206 is currently not in use for input as requested. By associating the input select register 232 to the GPIO pad 204 based on the first requested input connection, the control logic 159 may prevent a conflict where two GPIO pads 204, 206 are connected as input to the same block for two different programs.

If program A then closes the connection between hardware block 134 and GPIO pad 204, the control logic 159 may update the GPIO pad table 156 to indicate that GPIO pad 204 (pad index 2) is free. The control logic 159 may also update input select table 158 to set hardware block 134 (HW block index 3) to −1 to indicate the hardware block 134 is free. If program B then repeats the request to open an input connection between GPIO pad 206 and hardware block 134 via input select multiplexor 230, the control logic 159 may determine that the GPIO pad 206 is available based on GPIO pad table 156 storing a value of −1 indicating no program has claimed GPIO pad 206. The control logic 159 may also determine that the requested GPIO pad 206 is associated with an input select multiplexor 230. Now, the input select table 158 may indicate associated input select multiplexor 230 for hardware block 134 (HW block index 3) is available (e.g., not currently connected to a GPIO pad) based on input select table 158 storing a value of −1. The control logic 159 may therefore allow the request. The control logic 159 may update the GPIO pad table 156 by setting the GPIO pad 206 (pad index 3) to program B and update the input select table 158 by setting the input select register 232 for hardware block 134 (HW block index 3) to the value 3 indicating GPIO pad 206.

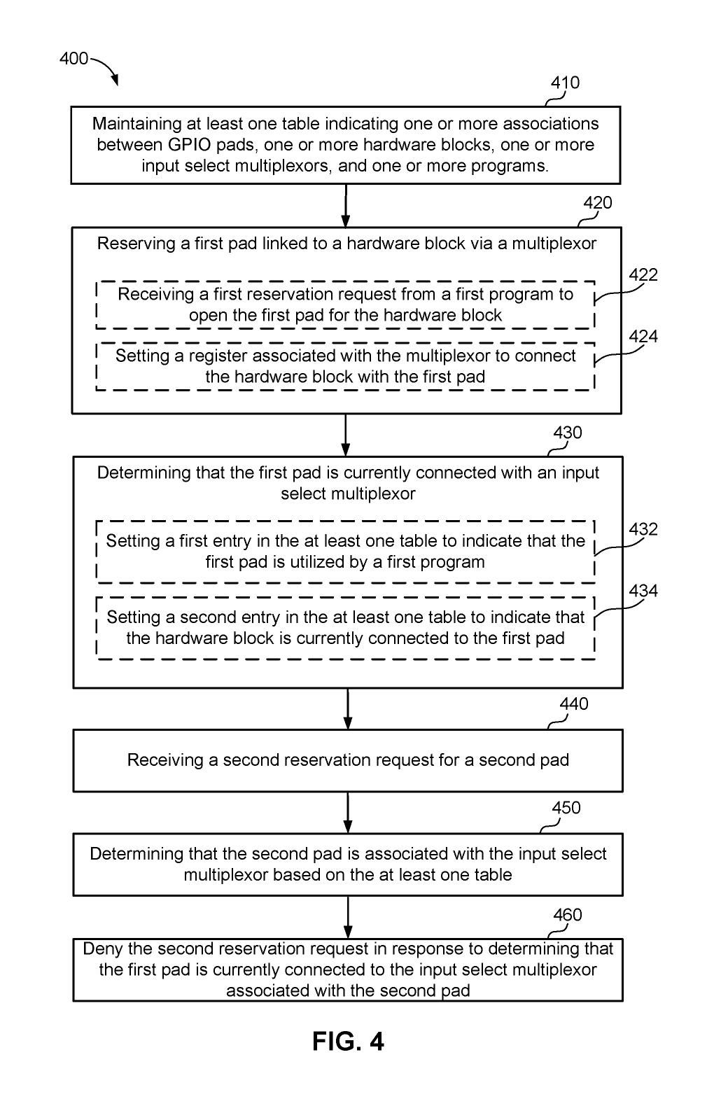

Referring now to FIG. 4, an example method 400 provides for GPIO pad access control for the chip 100. For example, method 400 may be used for controlling access to GPIO pins 112, 114, 116. The method 400 may be performed by the processor 140 executing instructions of the operating system 150 and/or the input-output manager 152.

At 410, method 400 may include maintaining at least one table indicating one or more associations between GPIO pads, one or more hardware blocks, one or more input select multiplexors, and one or more programs. For example, in an implementation, the input-output manager 152 may maintain the hardware configuration table 154, GPIO pad table 156 and/or the input select table 158. The input-output manager 152 may generate the GPIO pad table 156 and/or the input select table 158 based on the hardware configuration table 154. For example, the input-output manager 152 may generate an entry in GPIO pad table 156 corresponding to each GPIO pad 202, 204, 206 and generate an entry in input select table 158 for each hardware block 130, 132, 134 associated with an input select multiplexor 230 or input select register 232. The control logic 159 may maintain the at least one table by updating the entries when a status of a register 222, 224, 226 or input select register 232 changes, for example, when a resource is successfully reserved or released.

At 420, the method 400 may include reserving a first pad linked to a hardware block via a multiplexor. For example, in an implementation, the control logic 159 may reserve a first pad (e.g., GPIO pad 206) linked to a hardware block (e.g., hardware block 134) via a multiplexor (e.g., multiplexor 216). The control logic 159 may reserve the first pad when a first reservation request is successful. For example, at 422, the action 420 may optionally include receiving a first reservation request from a first program to open the first pad for the hardware block. For instance, the control logic 159 may receive the first reservation request from a first program (e.g., program A) to open the GPIO pad 206 for the hardware block 134. At 424, the action 420 may optionally include setting a register associated with the multiplexor to connect the hardware block with the first pad. For example, the control logic 159 may set the register 226 associated with the multiplexor 216 to connect the hardware block 134 with the GPIO pad 206.

At 430, the method 400 may include determining that the first pad is currently connected to an input select multiplexor. For example, in an implementation, the control logic 159 may determine that the GPIO pad 206 is currently connected to an input select multiplexor 230. For example, the control logic 159 may check the hardware configuration table 154 to determine whether any input select register is associated with the GPIO pad 206. In response to reserving a GPIO pad 206, at 432, the action 430 may optionally include setting a first entry in the at least one table to indicate that the first pad is utilized by a first program. For instance, the control logic 159 may set a value of an entry in the GPIO pad table 156 to indicate that the GPIO pad 206 is utilized by the first program. Additionally, at 434, the action 430 may optionally include setting a second entry in the at least one table to indicate that the hardware block is currently connected to the first pad. For instance, the control logic 159 may set a value of an entry in the input select table 158 to indicate that the GPIO pad 206 is currently connected to an input select multiplexor 230 for the hardware block 134.

At 440, the method 400 may include receiving a second reservation request for a second pad. In an implementation, for example, the control logic 159 may receive a second reservation request for a second GPIO pad (e.g., GPIO pad 204). The second reservation request may be a request to open the second pad for input to the hardware block. For example, the second reservation request may request to open the GPIO pad 204 for input to the hardware block 134 via the input select multiplexor 230 associated with the input select register 232.

At 450, the method 400 may include determining that the second pad is associated with the input select multiplexor based on the at least one table. For instance, the control logic 159 may determine that the GPIO pad 204 is associated with the input select multiplexor 230 based on the hardware configuration table 154. For example, the control logic 159 may check the hardware configuration table 154 to determine potential input select multiplexors or input select registers (or corresponding hardware blocks) that may be associated with the second GPIO pad 204. The control logic 159 may also check the input select table 158 to determine whether any of the potential input select multiplexors or input select registers are associated with another GPIO pad.

At 460, the method 400 may include denying the second reservation request in response to determining that the first pad is currently connected to the input select multiplexor associated with the second pad. In an implementation, for example, the input-output manager 152 may indicate to the second program that the second reservation request has been denied. For example, the input-output manager 152 may deny the second reservation request in response to determining that the first GPIO pad 206 is currently connected to the input select multiplexor 230, which is also associated with the second GPIO pad 204. The control logic 159 may determine that the first GPIO pad 206 is currently connected to the input select multiplexor 230 when the input select table 158 indicates the connection between the hardware block 134 and the first GPIO pad 206 (e.g., indicating that the hardware block corresponding to the input select multiplexor 230 is connected to the first GPIO pad). Denying the second reservation request may include sending an indication including an error code providing a reason the request failed. Accordingly, the method 400 may control access to GPIO pads 202, 204, 206 to prevent conflicts, in particular, to prevent conflicts between requests for different programs to open input and output connections between the same hardware blocks and/or GPIO pads.

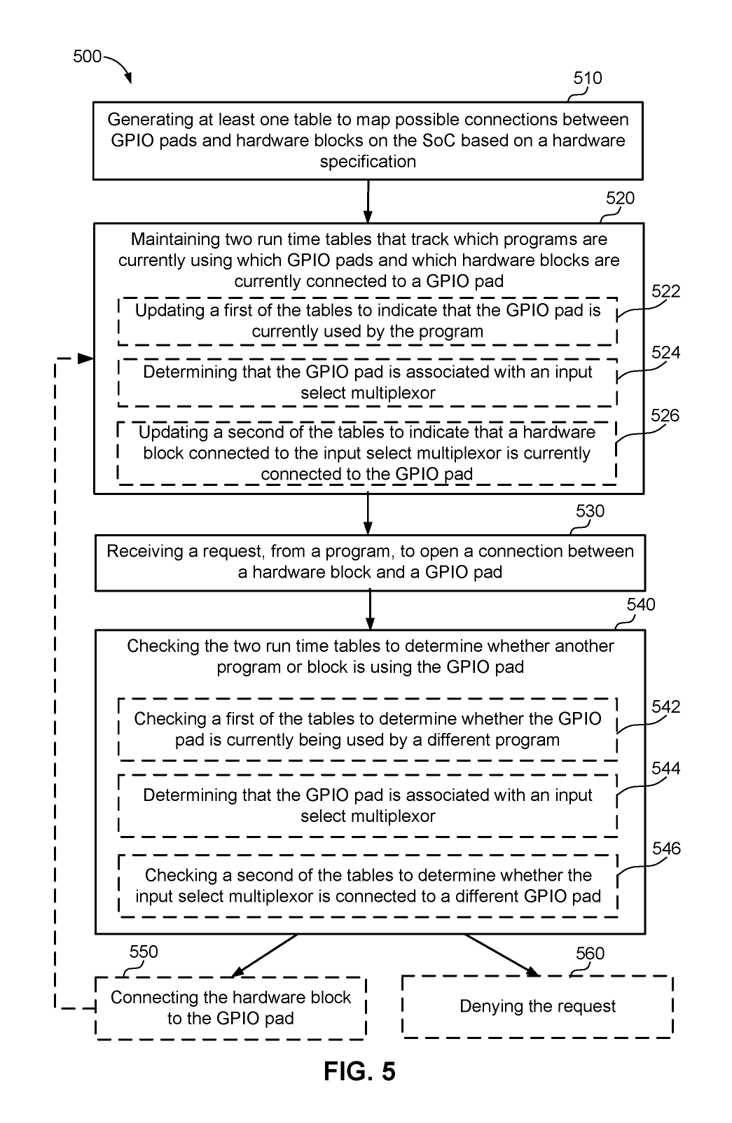

Referring now to FIG. 5, another example method 500 provides for GPIO pad access control for the chip 100. For example, method 500 may be used for controlling access to GPIO pins 112, 114, 116 or corresponding GPIO pads 202, 204, 206. The method 500 may be performed by the processor 140 executing instructions of the operating system 150 and/or the input-output manager 152.

At 510, the method 500 may include generating at least one table to map possible connections between GPIO pads and hardware blocks on the SoC based on a hardware specification. For instance, in an implementation, the processor 140 may generate the hardware configuration table 154 to map associations between GPIO pads 202, 204, 206 and hardware blocks 130, 132, 134. For example, the associations may indicate potential connections via multiplexors 212, 214, 216 and/or input select multiplexor 230.

At 510, the method 500 may include maintaining two run time tables that track which programs currently using which GPIO pads and which hardware blocks are currently connected to a GPIO pad. In an implementation, for example, the control logic 159 may maintain the GPIO pad table 156, which may track which programs are currently using which GPIO pads, and the input select table 158, which may track which hardware blocks currently connected to a GPIO pad. For example, at 522, the action 510 may include updating a first of the tables to indicate that the GPIO pad is currently used by a program. In an implementation, the control logic 159 may update the GPIO pad table 156 to indicate that a GPIO pad is currently used by the program whenever the control logic connects a GPIO pad to a hardware block when requested by the program. As another example, at 524, the action 520 may include determining that the GPIO pad is currently connected to an input select multiplexor. For instance, the control logic 159 may use the hardware configuration table 154 to determine whether a GPIO pad 204 is associated with an input select multiplexor 230. In response, at 526, the action 520 may include updating a second of the tables to indicate that a hardware block connected to the input select multiplexor is currently connected to the GPIO pad. For example, the control logic 159 may update the input select table 158 to indicate that a hardware block 134 connected to an input select multiplexor 230 is currently connected to the GPIO pad 204.

At 530, the method 500 may include receiving a request, from a program, to open a connection between a hardware block and a GPIO pad. For example, in an implementation, the processor 140 may receive a request from an application 160 to open a connection between a hardware block 130, 132, 134 and a GPIO pad 202, 204, 206.

At 540, the method 500 may include checking the two run time tables to determine whether another program or block is using the GPIO pad. For instance, in an implementation, the control logic 159 may check the GPIO pad table 156 and the input select table 158 to determine whether another application 160 or hardware block 130, 132, 134 is using the GPIO pad 202, 204, 206. For example, at 542, the action 540 may optionally include checking a first of the tables to determine whether the GPIO pad is currently being used by a different program. In an implementation, for instance, the control logic 159 may check the GPIO pad table 156 to determine whether the GPIO pad 202, 204, 206 is currently being used by another application 160. At 544, the action 540 may also optionally include determining that the GPIO pad is associated with an input select multiplexor. For instance, the control logic 159 may use the hardware configuration table 154 to determine whether a GPIO pad 202, 204, 206 is associated with an input select multiplexor 230. At 546, the action 540 may include checking a second of the tables to determine whether the input select multiplexor is currently connected to a different GPIO pad. For example, the control logic 159 may check the input select table 158 to determine whether the input select multiplexor 230 is currently connected to different GPIO pad 202, 204, 206.

At 550, the method 500 may optionally include connecting the hardware block to the GPIO pad. The action 550 may be performed in response to a request when the tables indicate that no other program or block is using the GPIO pad. For instance, the control logic 159 may connect the hardware block 132 to the GPIO pad 204. For example, the control logic 159 may set a value of the register 224 to control the multiplexor 214 to connect the hardware block 132 to the GPIO pad 204. The method 500 may then return to action 520 to maintain the tables based on the new connection.

At 560, the method 500 may optionally include denying the request. The action 560 may be performed when either the first of the tables indicates that the GPIO pad is currently claimed or the second of the tables indicates that the input select multiplexor is associated with a different GPIO pad. For example, the control logic 159 may deny the request when the GPIO pad table 156 indicates that the requested GPIO pad is currently claimed, or the input select table 158 indicates that the input select multiplexor 230 is already associated with a different GPIO pad. The control logic 159 may trigger the processor 140 to provide the application 160 with an indication that the request has been denied.

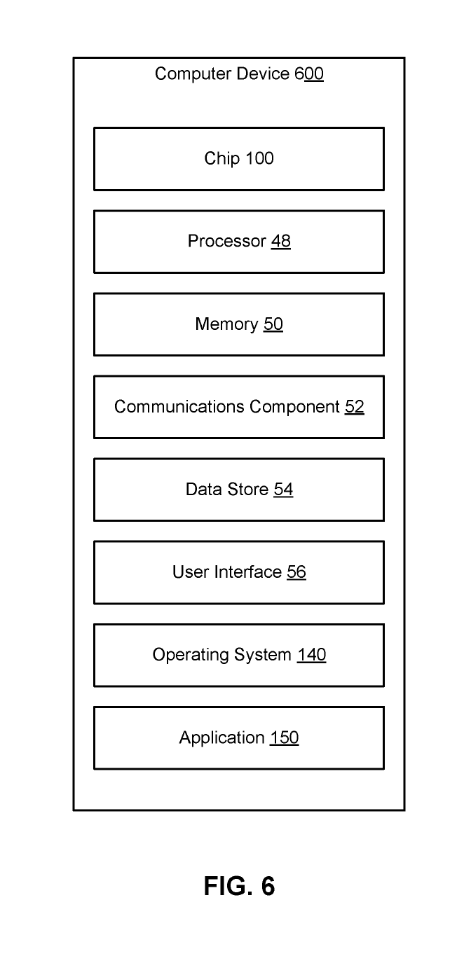

Referring now to FIG. 6, illustrated is an example computer device 600 in accordance with an implementation. The computer device 600 may include the chip 100 as well as additional component details as compared to FIG. 1. In one example, computer device 600 may include processor 48 for carrying out processing functions associated with one or more of components and functions described herein. Processor 48 can include a single or multiple set of processors or multi-core processors. Moreover, processor 48 can be implemented as an integrated processing system and/or a distributed processing system. In an implementation, for example, processor 48 may include processor 140. The processor 48 may also be a processor external to chip 100 for controlling the chip 100. In an example, computer device 600 may include memory 50 for storing instructions executable by the processor 48 for carrying out the functions described herein. In an implementation, for example, memory 50 may include memory 142. The memory 50 may also be a memory external to chip 100.

Further, computer device 600 may include a communications component 52 that provides for establishing and maintaining communications with one or more parties utilizing hardware, software, and services as described herein. Communications component 52 may carry communications between components on computer device 600, as well as between computer device 600 and external devices, such as devices located across a communications network and/or devices serially or locally connected to computer device 600. For example, communications component 52 may include one or more buses, and may further include transmit chain components and receive chain components associated with a transmitter and receiver, respectively, operable for interfacing with external devices.

Additionally, computer device 600 may include a data store 54, which can be any suitable combination of hardware and/or software, that provides for mass storage of information, databases, and programs employed in connection with implementations described herein. For example, data store 54 may be a data repository for operating system 150 (FIG. 1) and/or applications 160 (FIG. 1).

Computer device 600 may also include a user interface component 56 operable to receive inputs from a user of computer device 600 and further operable to generate outputs for presentation to the user. User interface component 56 may include one or more input devices, including but not limited to a keyboard, a number pad, a mouse, a touch-sensitive display, a digitizer, a navigation key, a function key, a microphone, a voice recognition component, any other mechanism capable of receiving an input from a user, or any combination thereof. Further, user interface component 56 may include one or more output devices, including but not limited to a display, a speaker, a haptic feedback mechanism, a printer, any other mechanism capable of presenting an output to a user, or any combination thereof.

In an implementation, user interface component 56 may transmit and/or receive messages corresponding to the operation of operating system 150 and/or application 160. In addition, processor 48 may execute operating system 150 and/or application 160, and memory 50 or data store 54 may store them.

As used in this application, the terms “component,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computer device and the computer device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Various implementations or features may have been presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

The various illustrative logics, logical blocks, and actions of methods described in connection with the embodiments disclosed herein may be implemented or performed with a specially-programmed one of a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computer devices, e.g., a combination of a DSP and a microprocessor, a plurality of microprocessors, one or more microprocessors in conjunction with a DSP core, or any other such configuration. Additionally, at least one processor may comprise one or more components operable to perform one or more of the steps and/or actions described above.

Further, the steps and/or actions of a method or procedure described in connection with the implementations disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some implementations, the processor and the storage medium may reside in an ASIC. Additionally, the ASIC may reside in a user terminal. In the alternative, the processor and the storage medium may reside as discrete components in a user terminal. Additionally, in some implementations, the steps and/or actions of a method or procedure may reside as one or any combination or set of codes and/or instructions on a machine readable medium and/or computer readable medium, which may be incorporated into a computer program product.

In one or more implementations, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs usually reproduce data optically with lasers. Combinations of the above should also be included within the scope of computer-readable media.

While implementations of the present disclosure have been described in connection with examples thereof, it will be understood by those skilled in the art that variations and modifications of the implementations described above may be made without departing from the scope hereof. Other implementations will be apparent to those skilled in the art from a consideration of the specification or from a practice in accordance with examples disclosed herein.

What is claimed is:

1. A method of controlling access to general purpose input/output (GPIO) pads of an electronic chip, comprising:
maintaining at least one table indicating one or more associations between the GPIO pads, one or more hardware blocks, one or more input select multiplexors, and one or more programs;
reserving a first pad linked to a hardware block via a multiplexor;
determining that the first pad is currently connected with an input select multiplexor in response to reserving the first pad based on the at least one table;
receiving a second reservation request for a second pad;
determining that the second pad is associated with the input select multiplexor based on the at least one table; and
denying the second reservation request in response to determining that the first pad is currently connected to the input select multiplexor associated with the second pad.

2. The method of claim 1, wherein reserving the first pad includes:
receiving a first reservation request from a first program to open the first pad for the hardware block; and
setting a register associated with the multiplexor to connect the hardware block with the first pad.

3. The method of claim 1, wherein determining that the first pad is currently connected with the input select multiplexor includes:
setting a first entry in the at least one table to indicate that the first pad is utilized by a first program; and
setting a second entry in the at least one table to indicate that the hardware block is currently connected to the first pad.

4. The method of claim 3, wherein the second reservation request is a request from a second program to open the second pad for input to the hardware block.

5. The method of claim 4, wherein denying the second reservation request in response to determining that the first pad is currently connected to the input select multiplexor, comprises:
determining that the input select multiplexor is associated with the hardware block;
determining that the second entry in the at least one table indicates that the hardware block is currently connected to the first pad; and
determining that the second pad is different than the first pad or that the first program is different than the second program.

6. The method of claim 1, wherein maintaining the at least one table comprises:
generating a hardware configuration table to map associations between GPIO pads and hardware blocks on the SoC based on a hardware specification; and
maintaining two run time tables that track which programs are currently using which GPIO pads and which hardware blocks are currently connected with a GPIO pad.

7. The method of claim 6, wherein the hardware specification indicates that at least one of the hardware blocks is connected to at least two GPIO pads via an input select multiplexor, wherein maintaining the two run time tables comprises indicating that the at least one hardware block is connected with a GPIO pad when any GPIO pad connected to the input select multiplexor is connected with one of the hardware blocks.

8. An electronic chip comprising:
a plurality of general purpose input/output (GPIO) pads;
one or more multiplexors connected with one or more of the GPIO pads and connected with one or more hardware blocks, wherein the one or more multiplexors control which hardware block is connected to the respective GPIO pad;
a register associated with each multiplexor;
an input select multiplexor associated with at least a subset of the GPIO pads via the one or more multiplexors and to a hardware block, wherein the input select multiplexor controls which GPIO pad is connected to the hardware block;
a memory storing one or more parameters or instructions for executing an operating system; and
at least one processor coupled to the memory, wherein the at least one processor is configured to:
maintain at least one table indicating one or more associations between the GPIO pads, the one or more hardware blocks, the input select multiplexor, and one or more programs;
reserve a first pad linked to a hardware block via a multiplexor;
determine that the first pad is currently connected with the input select multiplexor in response to reserving the first pad based on the at least one table;
receive a second reservation request for a second pad;
determine that the second pad is associated with the input select multiplexor based on the at least one table; and
deny the second reservation request in response to determining that the first pad is currently connected to the input select multiplexor associated with the second pad.

9. The electronic chip of claim 8, wherein the processor is configured to:
receive a first reservation request from a first program to open the first pad for the hardware block; and
set a register associated with the multiplexor to connect the hardware block with the first pad.

10. The electronic chip of claim 9, wherein the processor is configured to:
set a first entry in the table to indicate that the first pad is utilized by a first program; and
set a second entry in the table to indicate that the hardware block is connected to the first pad.

11. The electronic chip of claim 10, wherein the second reservation request is a request from a second program to open the second pad for input to the hardware block.

12. The electronic chip of claim 11, wherein the processor is configured to:
determine that the input select multiplexor is associated with the hardware block;
determine that the second entry in the at least one table indicates that the hardware block is currently connected to the first pad; and
deny the second reservation request when the second pad is different than the first pad or the first program is different than the second program.

13. The electronic chip of claim 8, wherein the processor is configured to
generate a hardware configuration table to map associations between GPIO pads and hardware blocks on the chip based on a hardware specification; and
maintain two run time tables that track which programs are currently using which GPIO pads and which hardware blocks are currently connected with a GPIO pad.

14. The electronic chip of claim 13, wherein the hardware specification indicates that at least one of the hardware blocks is connected to at least two GPIO pads via an input select multiplexor, wherein maintaining the two run time tables comprises indicating that the at least one hardware block is connected with a GPIO pad when any GPIO pad connected to the input select multiplexor is connected with one of the hardware blocks

15. A method of controlling access to general purpose input-output (GPIO) pads on a system-on-chip (SoC), comprising:
generating at least one configuration table to map possible connections between GPIO pads and hardware blocks on the SoC based on a hardware specification;
maintaining two run time tables that track which programs are currently using which GPIO pads and which hardware blocks are currently connected to a GPIO pad;
receiving a request, from a program, to open a connection between a hardware block and a GPIO pad; and
checking the two run time tables to determine whether another program or block is using the GPIO pad.

16. The method of claim 15, further comprising:
connecting the hardware block to the GPIO pad in response to the request when the tables indicates that no other program or block is using the GPIO pad, wherein maintaining the two run time tables comprises updating a first of the tables to indicate that the GPIO pad is being used by the program.

17. The method of claim 16, wherein maintaining the two run time tables further comprises:
determining that the GPIO pad is associated with an input select multiplexor; and
updating a second of the tables to indicate that a hardware block connected to the input select multiplexor is currently connected to the GPIO pad.

18. The method of claim 15, wherein the hardware specification indicates that at least one of the hardware blocks is connected to at least two GPIO pads via an input select multiplexor, wherein maintaining the two run time tables comprises indicating that the at least one hardware block is connected with a GPIO pad when any GPIO pad connected to the input select multiplexor is connected to one of the hardware blocks.

19. The method of claim 15, wherein checking the tables to determine whether another program or block is using the GPIO pad comprises:
checking a first of the tables to determine whether the GPIO pad is currently being used by a different program;
determining that the GPIO pad is associated with an input select multiplexor; and
checking a second of the tables to determine whether the input select multiplexor is currently connected to a different GPIO pad.

20. The method of claim 19, further comprising:
denying the request when either the first of the tables indicates that the GPIO pad is currently used by another program or the second of the tables indicates that the input select multiplexor is currently connected to a different GPIO pad.
